(19) United States
(12) Patent Application Publication
(10) Pub. No.: US 2005/0160687 A1
(43) Pub. Date: Jul. 28, 2005

(54) Window well cover

(76) Inventor: Pat Corry, New York, NY (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/762,438

(22) Filed: Jan. 22, 2004

(51) Int. Cl. E06B 5/02; E04F 17/06

(52) U.S. Cl. 52/107; 52/169.14; 52/171.1

(57) ABSTRACT

A protector for a window well is provided. A hood is formed in the shape of quarter sphere. The hood comprises a first and second portion, the first portion of the hood connected to a base and further comprising a plurality of slits and the second portion sloped to deflect precipitation from the first portion and the slits. A first outward rim flange extends from the top of the hood for securing the hood to a foundation. A second outward rim flange extends from the bottom of the hood for covering the window well. In certain embodiments according to the present invention, the first portion of the hood can be about perpendicular to the base.

### FIELD OF THE INVENTION

The present invention is directed to a novel and useful window well cover which affords protection for the well.

### BACKGROUND INFORMATION

In current construction, a window well is typically a cement or cinder block constructed structure depending outwardly from the foundation of the building, the well normally having a concrete base and allowing access to a window, grate, or door in the foundation of the structure. A structure having a full basement might have a window positioned in the structure foundation, and hence, the window well would allow the access of light to this window and into the basement area.

Window well covers are used to allow light to pass into the window well and at the same time prevent foreign material from entering the window well. For example, U.S. Pat. No. 3,046,613 to Smith, U.S. Pat. No. 3,128,508 to Burnham, U.S. Pat. No. 3,085,489 to Ivy, and U.S. Pat. No. 2,863,177 to Nelson purport to disclose various aspects of window well covers and are hereby included by reference. Additional prior art patents are not directed specifically to window well covers, but instead impart added functionality to the window well covers. For example, U.S. Pat. No. 6,165,065 to Pasij purports to disclose a vent assembly for a window of a window well cover.

### SUMMARY OF THE INVENTION

In a first embodiment according to the present invention, a protector for a window well is provided. A hood is formed in the shape of quarter sphere. The hood comprises a first and second portion, the first portion of the hood about perpendicular to a base and further comprising a plurality of slits and the second portion sloped to deflect precipitation from the first portion and the slits. Preferably, the protector is formed of a single piece structure.

In a second embodiment according to the present invention, a protector for a window well is provided. A hood is formed in the shape of quarter sphere. The hood comprises a first and second portion, the first portion of the hood connected to a base and further comprising a plurality of slits and the second portion sloped to deflect precipitation from the first portion and the slits. A first outward rim flange extends from the top of the hood for securing the hood to a foundation. A second outward rim flange extends from the bottom of the hood for covering the window well. In certain embodiments according to the present invention, the first portion of the hood can be about perpendicular to the base. Preferably, the protector is formed of a single piece structure.

In a third embodiment according to the present invention, a protector for a window well is provided. A hood is formed in the shape of quarter sphere. The hood comprises a first and second portion, the first portion of the hood about perpendicular to a base and further comprising a plurality of slits and the second portion sloped to deflect precipitation from the first portion and the slits. A first outward rim flange extends from the top of the hood for securing the hood to a foundation. A second outward rim flange extends from the bottom of the hood for covering the window well. The outward rim flanges comprise a plurality of securing members. Preferably, except for the securing members, the protector is formed of a single piece structure.

In a fourth embodiment of the present invention, a method for constructing a protector for a window well is provided. A moldable material is injected into a mold, the mold shaped to form a window well cover. The window well cover further comprises the shape of quarter sphere comprising a first and second portion. The first portion of the hood is about perpendicular to a base and further comprises a plurality of slits. The second portion is sloped to deflect precipitation from the slits. Also, a first outward rim flange that extends from the top of the hood for securing the hood to a foundation forms part of the window well cover. A second outward rim flange that extends from the bottom of the hood for covering the window well also forms part of the window well cover. The mold is removed after the material has solidified.

### BRIEF DESCRIPTION OF THE DRAWINGS

FIG. 1 is a perspective view of the window well cover from the front.

FIG. 2 is a top perspective view of the window.

FIG. 3 is a cut away side view of the window well from the side.

FIG. 4 shows a cut-away view of the slits.

FIG. 5 shows a further embodiment of the present invention including a hinge for mounting the window well cover to an adjacent wall.

### DETAILED DESCRIPTION OF THE PREFERRED EMBODIMENTS

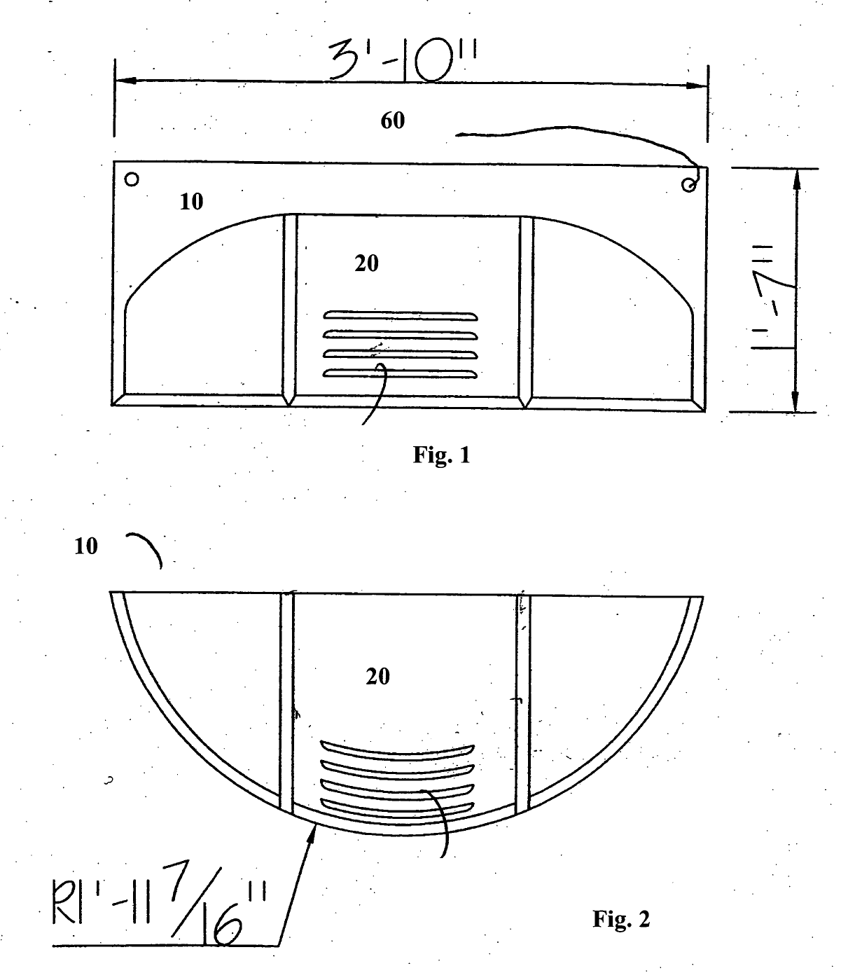

FIG. 1 is a perspective view of the window well cover 10 from the front. The window well cover 10 comprises a protective hood 20. Preferably, the protective hood 20 is formed from a sheet of sturdy transparent plastic material in order to allow light to pass into the well window. The protective hood 20 is of quarter semi-spherical shape, one end adapted to meet the surface of a building wall. The bottom quarter of the protective hood 20 comprises a plurality of slits 50 and is angled about perpendicular to the ground so that precipitation will pass over the slits 50 without entering the protective hood 20. The top three quarters of the protective hood 20 are shaped so that rain or other forms of precipitation run off the top of the protective hood 20 without entering the slits 50. Preferably, the slits 50 are parallel to each other and the ground. Most preferably, there are three slits 50. In certain embodiments according to the present invention, the bottom quarter of the protective hood 20 can be inclined so that it passes under the top three quarters.

The top of the hood is formed with a first outward rim flange 10 comprising two securing members 60, e.g., screw holes. The securing members 60 are used to secure the window well cover 10 to a building wall. In certain embodiments according to the present invention, the bottom of the hood can be formed with a second outward rim flange 70 comprising a plurality of second securing members, e.g., stake holes. The second securing members can be used to secure the window to the foundation. In certain embodiments according to the present invention, the second outward rim flange 70 of the hood is angled so that water runs downward off the second outward rim flange 70. Moreover, the second outward rim flange 70 can extend under the protective hood 20 so as to cover the entire window well.

The securing members can be reinforced, for example, by a means to counteract any strain that the hood imparts on the securing members. Such means could include a coil spring in the region of the stake or screw. The outer end of the coil spring could be formed into a hook or loop to engage the stake or screw.

In a certain embodiment according to the present invention, the window well cover 10 can be a one-piece structure (i.e., of integral construction). However, in such an embodiment, the securing members (discussed above) would be considered separate from the window well cover 10. Preferably, such a single-piece window well is made via injection molding.

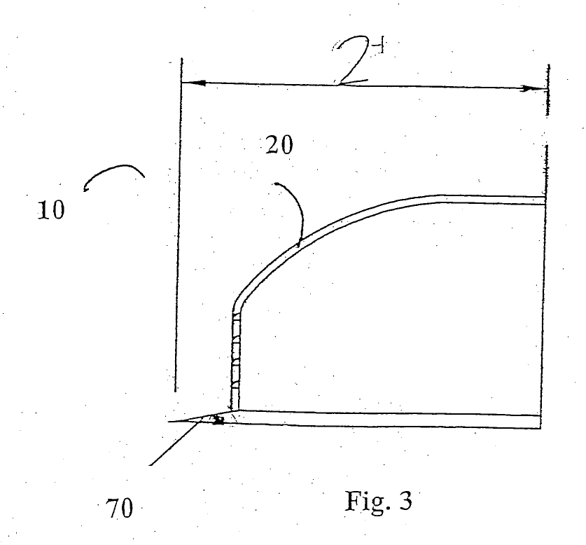

Preferably, the window well cover 10 has a length of about 3′ 10″ and a height of about 1′7″, as shown in FIG. 1. As can be seen in FIG. 2 the circumference of the half circle defining the base of the window well cover is, preferably, 1′ 11 7/16″. Also, the window well cover 10 may have a length of about 2′ from the back to the front, as shown in FIG. 3.

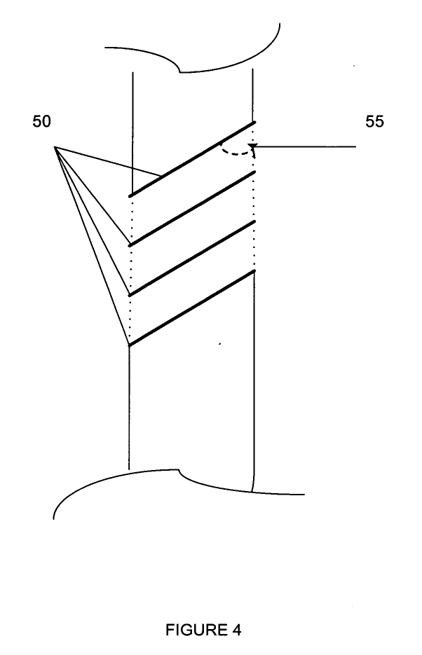

FIG. 4 shows a cut-away view of the slits 50. Preferably, the slits 50 are angled so that liquid that enters the slit 50 exits the slit 50 without entering the window well cover 50. For example, an angle 55 defined by the intersection of the bottom of the slit 50 with the inside of the window well cover 10 can be less than 90 degrees.

The entire window well cover 10 can be constructed of plastic. In certain embodiments according to the present invention, an injection type of mold could be used to construct the window. In a preferred embodiment, the window well cover 10 can be one piece of injection molded plastic (e.g., integral construction). However, in such an embodiment, the securing members (discussed above) would be considered separate from the window well cover 10.

As mentioned above, the window well cover 10 could be constructed, for example, by an injection molding method. A mold is constructed as known in the art. A liquid or semi-liquid material (e.g., moldable) that can harden into a solid at room temperature (e.g., moldable plastic) is then injected into the mold. The plastic hardens and the mold is removed. The now completed window well cover 10 remains. However, it should be apparent to one skilled in the art that the injection molding method is exemplary and other methods of constructing the window well cover 10 could be used. For example, the window well cover 10 could be constructed by removing plastic from a block of plastic.

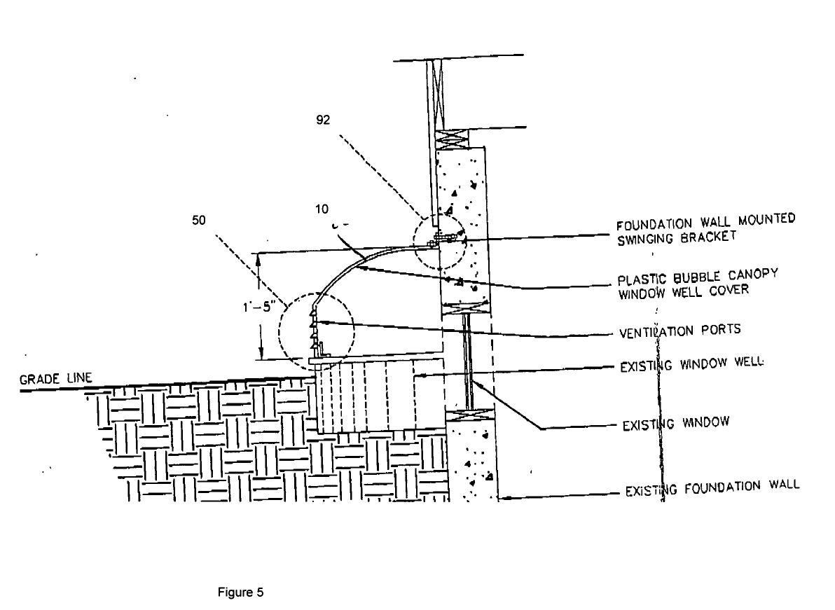

FIG. 5 shows a further embodiment of the present invention wherein the window well cover 10 is mounted to an adjacent wall (e.g., the wall adjacent to the window) via a hinge or swinging bracket 92. In this illustration, the wall forms part of the foundation of the building, and when the hinge 92 is mounted to the wall, the cover 10 can be moved vertically and in a clockwise direction (from the perspective shown in FIG. 5) to provide access to the window well.

1. A protector for a window well comprising:
a hood formed in the shape of quarter sphere comprising a first and second portion, the first portion of the hood about perpendicular to a base and further comprising a plurality of slits, the second portion sloped to deflect precipitation from the first portion and the slits.

2. A protector for a window well comprising:
a hood formed in the shape of quarter sphere comprising a first and second portion, the first portion of the hood about perpendicular to a base and further comprising a plurality of slits, the second portion sloped to deflect precipitation from the slits;
a first outward rim flange extending from the top of the hood for securing the hood to a foundation; and
a second outward rim flange extending from the bottom of the hood for covering the window well.

3. A protector for a window well comprising:
a hood formed in the shape of quarter sphere comprising a first and second portion, the first portion of the hood about perpendicular to a base and further comprising a plurality of slits, the second portion sloped to deflect precipitation from the slits;
a first outward rim flange extending from the top of the hood for securing the hood to a foundation and comprising a plurality of securing members; and
a second outward rim flange extending from the bottom of the hood for covering the window well.

4. The protector as described in claim 1 wherein the hood is a single piece.

5. The protector as described in claim 2 wherein the hood, and flanges are a single piece.

6. The protector as described in claim 1 wherein the hood is transparent.

7. The protector as described in claim 2 wherein the hood is transparent.

8. The protector as described in claim 3 wherein the hood is transparent

9. The protector as described in claim 1 wherein the hood is plastic.

10. The protector as described in claim 2 wherein the hood and flanges are plastic.

11. The protector as described in claim 3 wherein the hood and flanges are plastic.

12. The protector as described in claim 1 wherein the hood is constructed by injection molding.

13. The protector as described in claim 2 wherein the hood is constructed by injection molding.

14. The protector as described in claim 3 wherein the hood is constructed by injection molding.

15. The protector as described in claim 2 wherein the second outward rim flange covers the entire window well.

16. The protector as described in claim 3 wherein the second outward rim flange covers the entire window well.

17. The protector as described in claim 2 wherein the second outward rim flange comprises a plurality of securing members for securing the protector to a foundation.

18. The protector as described in claim 3 wherein the second outward rim flange comprises a plurality of securing members for securing the protector to a foundation.

19. The protector as described in claim 2 wherein the first outward rim flange comprises a plurality of securing members for securing the protector to a foundation

20. The protector as described in claim 1 further comprising a plurality of securing members for securing the protector to a foundation.

21. A method for constructing a protector for a window well comprising:
injecting a moldable material into a mold, the mold shaped to form a window well cover, wherein the window well cover further comprises:
a hood in the shape of quarter sphere comprising a first and second portion, the first portion of the hood about perpendicular to a base and further comprising a plurality of slits, the second portion sloped to deflect precipitation from the slits;
a first outward rim flange extending from the top of the hood for securing the hood to a foundation;
a second outward rim flange extending from the bottom of the hood for covering the window well; and
removing the mold after the material has solidified.

22. The method as recited in claim 21 wherein the material is plastic.

23. The method as recited in claim 21 wherein the material is transparent.

24. A protector for a window well comprising:
a hood formed in the shape of quarter sphere comprising a first and second portion, the first portion of the hood connected to a base and further comprising a plurality of slits, the second portion sloped to deflect precipitation from the slits;
a first outward rim flange extending from the top of the hood for securing the hood to a foundation; and
a second outward rim flange extending from the bottom of the hood for covering the window well.

25. The protector as described in claim 1 wherein the hood is a single piece.

26. The protector as described in claim 2 wherein the hood and flanges are a single piece.

27. The protector as described in claim 3 wherein the hood and flanges are a single piece.

28. The protector as described in claim 24 wherein the hood and flanges are a single piece.

29. The protector as described in claim 21 wherein the hood and flanges are a single piece.

30. A protector for a window well comprising:
a single-piece structure including a hood formed in the shape of quarter sphere comprising a first and second portion, the first portion of the hood about perpendicular to a base and further comprising a plurality of slits, the second portion sloped to deflect precipitation from the first portion and the slits.

31. A protector for a window well comprising:
a hood formed in the shape of quarter sphere comprising a first and second portion, the first portion of the hood about perpendicular to a base and further comprising a plurality of slits, the second portion sloped to deflect precipitation from the first portion and the slits;
a hinge coupled to the second portion.

32. The protector of claim 2, further comprising a hinge secured to the first outward rim flange.

33. The protector of claim 3, further comprising a hinge secured to the first outward rim flange.

34. The method of claim 21, further comprising securing a hinge to the first outward rim flange.

35. The protector of claim 24, further comprising a hinge secured to the first outward rim flange.

36. The protector of claim 30, further comprising a hinge secured to the first outward rim flange.
